(19) United States
(12) Patent Application Publication
(10) Pub. No.: US 2026/0018644 A1
(43) Pub. Date: Jan. 15, 2026

(54) MANIFOLD ASSEMBLY, STACK END PLATE, AND DUAL-STACK FUEL CELL SYSTEM

(71) Applicants: Robert Bosch GmbH, Stuttgart (DE); Bosch Hydrogen Powertrain Systems (Chongqing) Co., Ltd., Chongping (CN)

(72) Inventors: Lin Yang, Chongqing (CN); Fengming Dai, Chongqing (CN); Junhua Wang, Chongqing (CN)

(21) Appl. No.: 19/266,911

(22) Filed: Jul. 11, 2025

(30) Foreign Application Priority Data
Jul. 12, 2024 (CN) 2024 2165 8701.X

(51) Int. Cl. H01M 8/2484; H01M 8/04029; H01M 8/04082; H01M 8/249

(52) U.S. Cl. CPC H01M 8/2484; H01M 8/04029; H01M 8/04201; H01M 8/249

(57) ABSTRACT

A manifold assembly for a dual-stack fuel cell system includes a first manifold structure for delivering one of an oxidant and a coolant, the first manifold structure including a first branch channel and a first main manifold channel in fluid communication with the first branch channel and extending at least partially superposed over the first branch channel, wherein the first branch channel is open on a side opposite to the first main manifold channel for sealing connection to a surface of a stack end plate, such that one of the oxidant and coolant is guided along the surface of the stack end plate therein. The manifold assembly further includes a second manifold structure for delivering the other of the oxidant and coolant, the second manifold structure including two end plate interfaces configured to be connected to the stack end plate in a manner perpendicular to the surface of the stack end plate, a second branch passage fluidly connecting the two end plate interfaces, and a second main manifold channel in fluid communication with and extending at least partially superposed over the second branch passage. A stack end plate and a dual-stack fuel cell system are also disclosed.

This application claims priority under 35 U.S.C. § 119 to application no. CN 2024 2165 8701.X, filed on Jul. 12, 2024 in China, the disclosure of which is incorporated herein by reference in its entirety.

The present application generally relates to the field of fuel cell technology, and more specifically to a manifold assembly for dual-stack fuel cell systems, a stack end plate for use in conjunction with the manifold assembly, and a dual-stack fuel cell system employing the manifold assembly as an inlet distribution channel structure and/or outlet collection channel structure for oxidant and coolant.

### BACKGROUND

Fuel cells are a power generation technology with increasingly widespread applications. They convert the chemical energy of fuel directly into electrical energy via an electrochemical reaction with an oxidant. Compared to traditional combustion-based power generation technologies, fuel cells offer higher conversion efficiency, lower pollutant emissions, and quiet, reliable operation.

In the widely used proton exchange membrane fuel cells, a solid-state proton membrane is employed as the electrolyte for proton conduction. Accordingly, in fuel cells utilizing similar solid electrolytes, in addition to supplying the fuel (e.g., hydrogen) and oxidant (e.g., air) necessary for the electrochemical reaction, a coolant (e.g., water) must also be supplied to circulate through the fuel cell to absorb reaction heat, thereby ensuring safe operation of the fuel cell. As such, in the configuration of a fuel cell stack (hereinafter also referred to as “stack”) formed by serially stacking multiple unit fuel cells, six (6) ports are provided for the input and output of three different working media. These six ports may be directly or indirectly connected to various Balance of Plant (BOP) devices to facilitate the management and utilization (e.g., supply, circulation, filtration, and control of physical and/or chemical characteristics such as flow direction, flow rate, pressure, temperature, etc.) of the three working media (i.e., fuel, oxidant, and coolant).

In certain applications, to meet specified requirements for electrical power, voltage, and/or current, two or more stacks may be connected in series, in parallel, or in a series-parallel combination. Accordingly, in dual-stack or multi-stack fuel cell systems, manifolds may be used to distribute working media among multiple stacks and to receive and collect the corresponding working media output from the outlet ports of multiple stacks. Thus, for the input and output of the three different working media, the use of six manifolds may be involved. Given the limited installation space for fuel cell stack systems, and the fact that an increased number of stacks already occupies most of the available space, how to rationally plan the distribution and configuration of the six manifolds to fully utilize the space and avoid waste (e.g., by reducing the formation of inaccessible or unusable gap spaces) is an urgent problem to be solved in the field.

### SUMMARY

The present application proposes a design concept for a nested manifold assembly, aiming to address issues in the prior art such as disorganized manifold assembly arrangements, excessive space occupation, and the difficulty in utilizing the gap spaces formed thereby.

According to one aspect of the present application, a manifold assembly for a dual-stack fuel cell system is provided. The manifold assembly comprises: a first manifold structure for delivering one of an oxidant and a coolant, the first manifold structure including a first branch channel and a first main manifold channel in fluid communication with the first branch channel and extending at least partially superposed over the first branch channel, wherein the first branch channel is open on a side opposite to the first main manifold channel for sealing connection to a surface of a stack end plate, such that one of the oxidant and coolant is guided along the surface of the stack end plate therein; and a second manifold structure for delivering the other of the oxidant and coolant, the second manifold structure including two end plate interfaces configured to be connected to the stack end plate in a manner perpendicular to the surface of the stack end plate, a second branch passage fluidly connecting the two end plate interfaces, and a second main manifold channel in fluid communication with and extending at least partially superposed over the second branch passage.

Optionally, the first manifold structure and the second manifold structure are each integrally formed and detachably connected together.

Optionally, the first branch channel of the first manifold structure is formed with a generally straight central channel section and two end channel sections extending substantially perpendicular to the central channel section from opposite ends thereof, and the first main manifold channel is fluidly connected to the first branch channel at an intermediate position of the central channel section.

Optionally, the two end plate interfaces of the second manifold structure are respectively disposed adjacent to a corresponding one of the two end channel sections, such that one of the two end plate interfaces is located between the two end channel sections and one of the two end channel sections is located between the two end plate interfaces.

Optionally, the two end plate interfaces are arranged in alignment with the two end channel sections, and the end plate interface located between the two end channel sections is adjacent to the central channel section.

Optionally, the first main manifold channel is formed with a first main manifold channel section I, which extends perpendicular to the central channel section of the first branch channel, and a first main manifold channel section II, which extends parallel to the central channel section from the first main manifold channel section I; and the second main manifold channel is formed with a second main manifold channel section I, which extends perpendicular to the second branch passage, and a second main manifold channel section II, which extends parallel to the second branch passage from the second main manifold channel section I.

Optionally, the first branch channel, the second branch passage, the first main manifold channel section II, and the second main manifold channel section II are arranged in a sequentially staggered manner, and/or the second main manifold channel section I is connected to the second branch passage at an equal distance from both end plate interfaces.

Optionally, the manifold assembly further comprises at least one of the following: a flat flange extending outward from the channel opening edge of the first branch channel, the flange being configured to abut the surface of the stack end plate and including a plurality of through holes around a third branch channel passing therethrough; an arcuate opening formed near each of the two end channel sections of the first branch channel for receiving an end plate interface, and an annular flange formed on each of the two end plate interfaces for controlling insertion of the end plate interface into the arcuate opening; a sensor interface provided in the first main manifold channel of the first manifold structure for detecting physical and/or chemical characteristics of one of the oxidant and coolant, and threads provided around and/or inside the sensor interface; a sensor interface provided in the second main manifold channel of the second manifold structure for detecting physical and/or chemical characteristics of the other of the oxidant and coolant, and threads provided around the sensor interface; one or more wire harness fixing threaded holes integrated into the first main manifold channel of the first manifold structure for mounting wire harness devices; a mounting flange formed at the end of the first main manifold channel section II of the first manifold structure, opposite to the end connected to the first main manifold channel section I, for interfacing with a device arranged upstream or downstream of the first manifold structure, and mounting screw holes provided in the mounting flange; a mounting flange formed at the end of the second main manifold channel section I of the second manifold structure, opposite to the end connected to the second branch passage, for interfacing with a device arranged upstream or downstream of the second manifold structure, and mounting screw holes provided in the mounting flange; a plurality of medium bypass branches extending parallel and/or perpendicular to the second main manifold channel section II; and the first manifold structure and the second manifold structure assembled together by way of bolted connection, wherein the bolted connection at least includes a bushing structure formed on the first manifold structure for the passage of bolts and interfacing threaded holes formed on the second manifold structure aligned with the bushing structure.

According to another aspect of the present application, a stack end plate for a dual-stack fuel cell system for use with the manifold assembly is provided, characterized in that the stack end plate is formed with end interfaces for input and output of oxidant and coolant for the first and second stacks of the dual-stack fuel cell system, wherein the end interfaces for input of oxidant and coolant for the first and second stacks are arranged in alignment on one side of the stack end plate, and the end interfaces for output of oxidant and coolant for the first and second stacks are arranged in alignment on the other side of the stack end plate opposite to said one side.

According to yet another aspect of the present application, a dual-stack fuel cell system is provided. The dual-stack fuel cell system comprises: first and second stacks arranged side by side; a stack end plate for encapsulating the first and second stacks as described above; a manifold assembly as described above sealingly connected to the oxidant and coolant input end interfaces of the stack end plate; and a manifold assembly as described above connected to the oxidant and coolant output end interfaces of the stack end plate.

### BRIEF DESCRIPTION OF THE DRAWINGS

The following is an explanation of the examples according to the principles of the present application in conjunction with the accompanying drawings. The accompanying drawings are provided to make the disclosure of the present application complete and sufficient, and to convey the concept of the present application to those skilled in the art in an intuitive manner. However, the accompanying drawings are only provided as examples and are not intended to be limiting. Without departing from the spirit and scope of the present disclosure, those skilled in the art may, as appropriate, adjust, modify, and/or substitute the specific implementations of the features illustrated in the accompanying drawings.

FIG. 1 is a schematic block diagram of a stack end plate of a dual-stack fuel cell system employing a nested manifold assembly in accordance with the principles disclosed herein. The figure illustrates the arrangement of input and output ports on the stack end plate for delivering three different working media.

FIG. 2A is a right-rear perspective view of one embodiment of a nested manifold assembly according to the principles of the present disclosure. This nested manifold assembly may be used as an oxidant and coolant inlet manifold assembly for the dual-stack fuel cell system shown in FIG. 1, for distributing the oxidant and coolant from the main delivery channels to the two stacks of the dual-stack fuel cell system.

FIG. 2B is a left-front perspective view of the nested manifold assembly of FIG. 2A, and FIG. 2C is a bottom elevation view of the nested manifold assembly of FIG. 2A.

FIG. 3A is a right-rear perspective view of another embodiment of a nested manifold assembly according to the principles of the present disclosure. This nested manifold assembly may be used as an oxidant and coolant outlet manifold assembly for the dual-stack fuel cell system shown in FIG. 1, for collecting the oxidant and coolant received from the two stacks of the dual-stack fuel cell system into the respective main delivery channels.

FIG. 3B is a left-front perspective view of the nested manifold assembly of FIG. 3A, and FIG. 3C is a bottom elevation view of the nested manifold assembly of FIG. 3A; and

FIG. 4 is a sectional view of region A in FIG. 3B, illustrating details of a sensor mounting interface.

### DETAILED DESCRIPTION

Although the following description primarily sets forth the principles of the present disclosure in connection with a dual-stack fuel cell system having two fuel cell stacks, the nested manifold assembly according to the principles of the present application is not thereby limited. As will be readily understood by those skilled in the art, the concept of the nested manifold assembly disclosed herein may also be applied to other multi-stack fuel cell systems.

After reading the present disclosure, those skilled in the art will be able to make corresponding modifications, substitutions, and/or adjustments as appropriate, and the inventors also intend that the principles disclosed herein may be practiced in ways different from those specifically described herein.

For ease of description, terms such as “fluid connection” and “fluid communication” are used herein to describe an element or feature that is configured, either directly (e.g., by mutual contact or abutment) or indirectly (e.g., by way of intermediate elements or features such as channels, pipelines, chambers, etc.), to form a flow path with another element or feature that allows fluid to flow from one element or feature to the other, or vice versa. The use of terms such as “first” and “second” is intended solely to distinguish one feature or element from another, and does not imply any limitation on the number and/or arrangement of such features or elements. Furthermore, the use of words such as “substantially,” “about,” or “approximately” indicates that the defined feature may deviate from the theoretical concept due to factors such as manufacturing tolerances, measurement accuracy, and/or rounding errors, without affecting the intended effect of the corresponding defined feature.

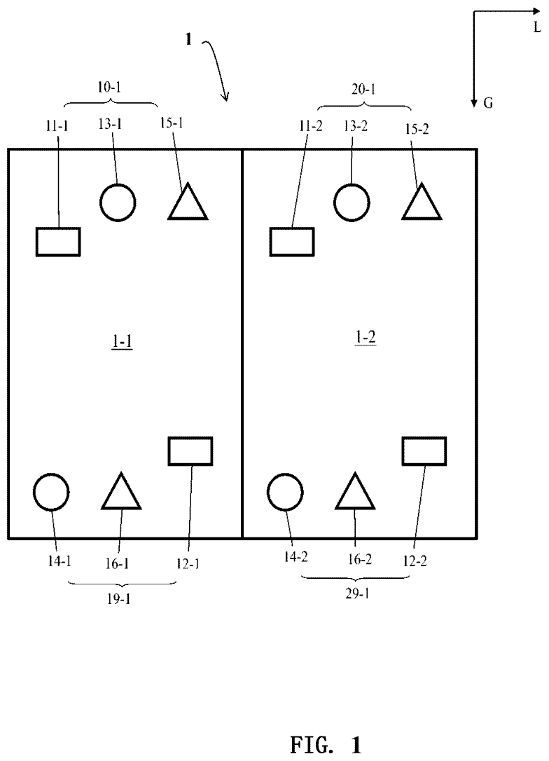

FIG. 1 schematically illustrates an arrangement structure of working medium end interfaces on a stack end plate 1 for a dual-stack fuel cell system. The dual-stack fuel cell system comprises a first stack and a second stack arranged side by side along the lateral direction L. For ease of identification, FIG. 1 uses different graphical symbols to indicate end interfaces for the same type of working medium. Specifically, rectangles indicate end interfaces for fuel, circles indicate end interfaces for oxidant, and triangles indicate end interfaces for coolant. However, it is understood that these are merely illustrative graphical symbols and are not intended to be limiting. On the other hand, the cross-sectional shapes of the working medium end interfaces on the stack end plate may include, but are not limited to, the geometric shapes shown in the figure. In addition, other ways of distinguishing between end interfaces for different working media, apart from shape differentiation, may also be used.

In the example of FIG. 1, the working medium end interfaces for the first stack are provided on the first side portion 1-1 of the stack end plate 1, which is used to encapsulate the first stack, and include a first working medium input end interface 10-1 and a first working medium output end interface 19-1, vertically separated along the gravity direction G. The first working medium input end interface 10-1 includes a first oxidant inlet 13-1 and a first coolant inlet 15-1, which are generally aligned along the lateral direction L, as well as a first fuel inlet 11-1, which is arranged below the first oxidant inlet 13-1 and the first coolant inlet 15-1 along the gravity direction G. The first working medium output end interface 19-1 is arranged below the first working medium input end interface 10-1 along the gravity direction G, and includes a first oxidant outlet 14-1 and a first coolant outlet 16-1, which are laterally adjacent and generally aligned at a first vertical height, as well as a first fuel outlet 12-1, which is arranged separately from the first oxidant outlet 14-1 and the first coolant outlet 16-1 at a second vertical height. Along the gravity direction G, the second vertical height is higher than the first vertical height, such that the first fuel outlet 12-1 is positioned closer to the first fuel inlet 11-1 than the first oxidant outlet 14-1 and the first coolant outlet 16-1. Thus, along the vertical direction, the first fuel inlet 11-1 and the first fuel outlet 12-1 for fuel delivery are arranged between the first oxidant inlet 13-1 and the first coolant inlet 15-1 for oxidant and coolant input, and the first oxidant outlet 14-1 and the first coolant outlet 16-1 for oxidant and coolant output.

Similarly, the working medium end interfaces for the second stack are provided on the second side portion 1-2 of the stack end plate 1, which is used to encapsulate the second stack, and include a second working medium input end interface 20-1 and a second working medium output end interface 29-1, vertically separated along the gravity direction G. The second working medium input end interface 20-1 include a second oxidant inlet 13-2 and a second coolant inlet 15-2, which are generally aligned along the lateral direction L, as well as a second fuel inlet 11-2, which is arranged below the second oxidant inlet 13-2 and the second coolant inlet 15-2 along the gravity direction G. The second working medium output end interface 29-1 is arranged below the second working medium input end interface 20-1 along the gravity direction G, and includes a second oxidant outlet 14-2 and a second coolant outlet 16-2, which are laterally adjacent and generally aligned at a first vertical height, as well as a second fuel outlet 12-2, which is arranged separately from the second oxidant outlet 14-2 and the second coolant outlet 16-2 at a second vertical height. Along the gravity direction G, the second vertical height is higher than the first vertical height, such that the second fuel outlet 12-2 is positioned closer to the second fuel inlet 11-2 than the second oxidant outlet 14-2 and the second coolant outlet 16-2. Thus, the second fuel inlet 11-2 and the second fuel outlet 12-2 for fuel delivery are vertically arranged between the second oxidant inlet 13-2 and the second coolant inlet 15-2 for oxidant and coolant input, and the second oxidant outlet 14-2 and the second coolant outlet 16-2 for oxidant and coolant output.

Accordingly, the end interfaces for fuel delivery (i.e., the first fuel inlet 11-1, second fuel inlet 11-2, first fuel outlet 12-1, and second fuel outlet 12-2) are centrally arranged in the vertical middle portion of the stack end plate 1, and may be fluidly connected to an integrated channel module dedicated to fuel delivery for forming the anode subsystem of the fuel cell system. For example, an exemplary integrated channel module for the anode side of a dual-stack fuel cell system is disclosed in the applicant's Chinese patent application No. 202420565665.6, the content of which is hereby incorporated by reference.

Furthermore, the end interfaces for oxidant and coolant delivery are separately arranged near the vertical top and bottom of the stack end plate 1. Specifically, in the example of FIG. 1, the first oxidant inlet 13-1, first coolant inlet 15-1, second oxidant inlet 13-2, and second coolant inlet 15-2 for oxidant and coolant input are sequentially arranged along the top edge of the stack end plate 1 at a certain distance from the top edge, and the first oxidant outlet 14-1, first coolant outlet 16-1, second oxidant outlet 14-2, and second coolant outlet 16-2 for oxidant and coolant output are sequentially arranged along the bottom edge of the stack end plate 1 at a certain distance from the bottom edge. Accordingly, a nested manifold assembly according to the principles of the present disclosure may be used to connect the input end interfaces for oxidant and coolant arranged along the top edge, and a nested manifold assembly according to the principles of the present disclosure may be used to connect the output end interfaces for oxidant and coolant arranged along the bottom edge.

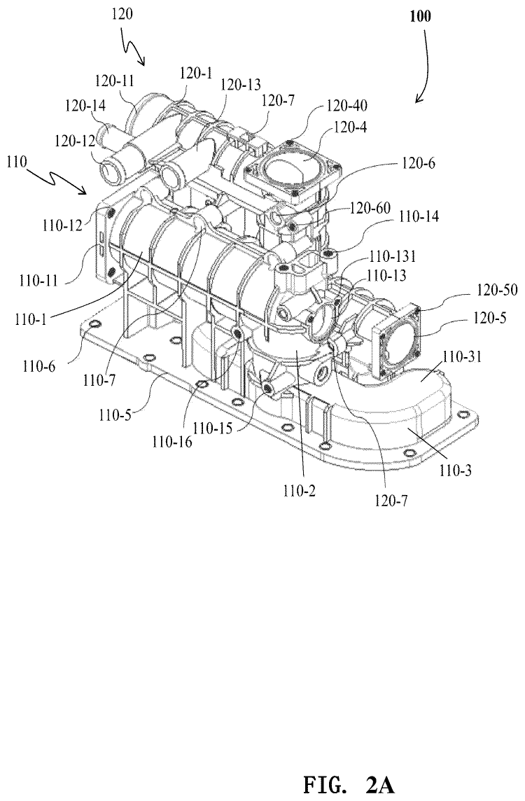

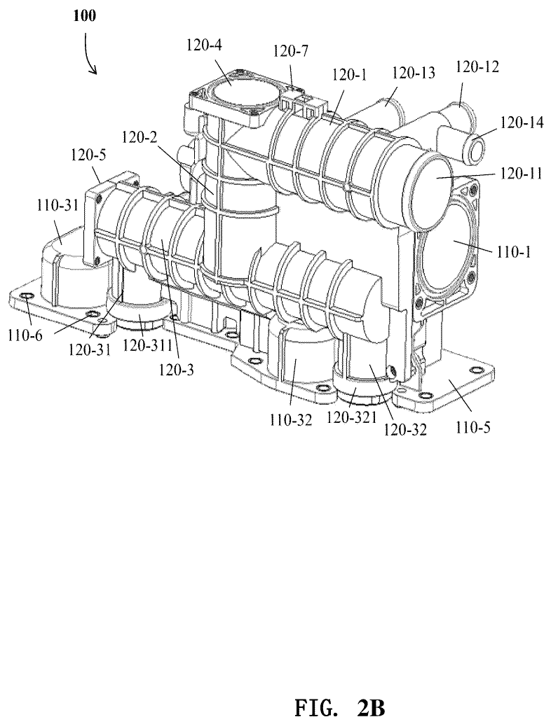

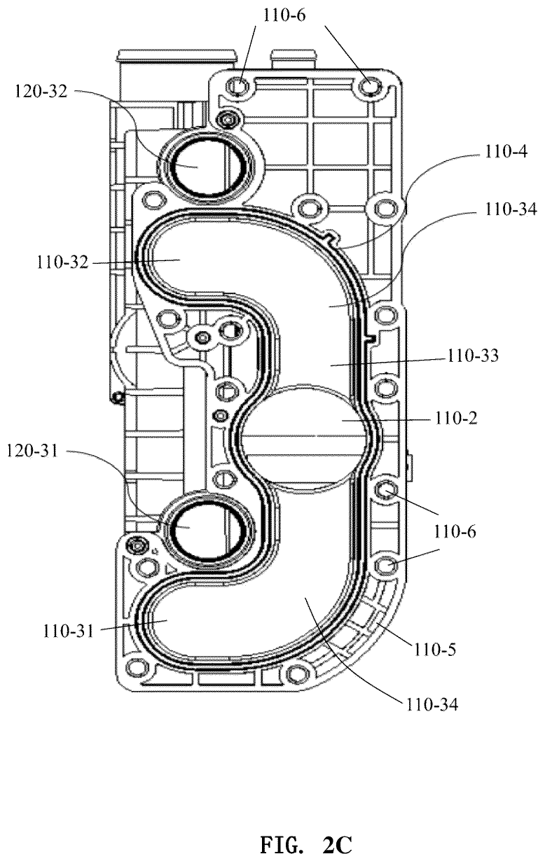

FIGS. 2A-2C illustrate one embodiment of a nested manifold assembly 100 according to the principles of the present disclosure, which may be used as an oxidant and coolant inlet manifold assembly. As shown in FIGS. 2A-2C, the nested manifold assembly 100 comprises a first manifold structure 110 configured to respectively deliver oxidant to a first oxidant inlet 13-1 and a second oxidant inlet 13-2, and a second manifold structure 120, which is arranged independently of the first manifold structure 110 and configured to respectively deliver coolant to a first coolant inlet 15-1 and a second coolant inlet 15-2.

As best seen in FIG. 2A, the first manifold structure 110 includes a first main manifold channel 110-1 that extends generally straight along a first direction, a second main manifold channel 110-2 that extends generally straight from the end of the first main manifold channel 110-1 in a second direction perpendicular to the first direction, and a third branch channel 110-3 that extends from the end of the second main manifold channel 110-2 opposite to the end connected to the first main manifold channel 110-1, along a plane perpendicular to the second direction and parallel to the first direction. The first main manifold channel 110-1, the second main manifold channel 110-2, and the third branch channel 110-3 are in fluid communication, thereby enabling the first manifold structure 110 to deliver the working medium (oxidant in this example) from an inflow opening 110-11 of the first manifold structure 110, which is configured for interfacing with an upstream BOP device (e.g., a control valve) and is located at the end of the first main manifold channel 110-1 opposite to the end connected to the second main manifold channel 110-2, to a first first manifold end plate interface 110-31 and a second first manifold end plate interface 110-32, which are respectively formed at the two ends of the third branch channel 110-3 and configured for interfacing with the first oxidant inlet 13-1 and the second oxidant inlet 13-2.

Referring to FIGS. 2C and 2A, the third branch channel 110-3 is formed as a channel open on the side facing away from the first main manifold channel 110-1 and the second main manifold channel 110-2, so as to allow the oxidant from the upstream BOP device to be distributed to the first oxidant inlet 13-1 and the second oxidant inlet 13-2 along the interfacing surface of the stack end plate 1 to which the open side of the channel is connected. Accordingly, a groove 110-4 and a flange 110-5 are formed along the edge of the third branch channel 110-3. The groove 110-4 closely surrounds the third branch channel 110-3 and is configured to accommodate a seal so that the working medium delivered via the third branch channel 110-3 is confined and guided within the third branch channel. Correspondingly, the flange 110-5 extends outwardly from the side wall of the channel defining the third branch channel 110-3 in a direction perpendicular to the second direction and away from the third branch channel 110-3, and is configured to be mounted against the interfacing surface of the stack end plate 1 so as to sealingly connect the third branch channel 110-3 of the first manifold structure 110, and thus the nested manifold assembly 100, to the stack end plate 1, thereby forming a complete working medium distribution channel together with the interfacing surface of the stack end plate 1 and the third branch channel 110-3. Preferably, the nested manifold assembly 100 is fastened to the stack end plate 1 by bolts, and multiple through holes 110-6 for bolts are provided in the flange 110-5 around the third branch channel 110-3.

Continuing with reference to FIGS. 2C and 2A, the third branch channel 110-3 has a generally C-shaped configuration and includes a generally straight central channel section 110-33 extending along the first direction, a first first manifold end plate interface 110-31 and a second first manifold end plate interface 110-32 spaced apart from the central channel section 110-33 in a third direction orthogonal to the first and second directions, and two transition channel sections 110-34 that connect the first first manifold end plate interface 110-31 and the second first manifold end plate interface 110-32 in parallel along the third direction to the central channel section 110-31. The transition channel sections 110-34 are formed with rounded corners or arcuate shapes to provide a smooth transition from the central channel section 110-33 to the first first manifold end plate interface 110-31 and the second first manifold end plate interface 110-32, and to allow the first second manifold end plate interface 120-31 (described below) of the second manifold structure 120 to be arranged adjacent to the first first manifold end plate interface 110-31 of the first manifold structure 110 and close to the central channel section 110-31, as best illustrated in FIG. 2C. Preferably, the transition channel sections 110-34 are configured to guide a fluid flow direction deflection of approximately 90°. The second main manifold channel 110-2 is connected to the third branch channel 110-3 at an intermediate position of the central channel section 110-33, such that the flow paths and/or flow resistance coefficients from the connection point of the third branch channel 110-3 and the second main manifold channel 110-2 to the first first manifold end plate interface 110-31 and to the second first manifold end plate interface 110-32 are substantially the same, thereby allowing the working medium to be distributed substantially evenly to the first and second stacks. Furthermore, as can be seen from FIGS. 2A and 2B, the first main manifold channel 110-1 partially overlaps a portion of the central channel section 110-33 and the transition channel sections 110-34, and partially overlaps the flange 110-5, such that the first manifold structure 110 has a compact arrangement and enhanced overall structural strength.

In the embodiment of FIGS. 2A-2C, the main body of the first manifold structure 110 is integrally formed of plastic (e.g., PPS+GF40%) using an injection molding process. Apart from the features related to the transfer of working media as described above, the first manifold structure 110 further comprises several auxiliary functional features. For example, a mounting flange 110-12 is formed around the inflow opening 110-11 of the first manifold structure 110, the mounting flange being configured for interfacing the first manifold structure 110 with an upstream BOP (Balance of Plant) device.

At the opposite end of the first main manifold channel 110-1 from the inflow opening 110-11 along the first direction, a sensor interface 110-13 is formed to allow interfacing with sensors for detecting physical and/or chemical characteristics (such as pressure, temperature, flow rate, etc.) of the working medium flowing into the first manifold structure. The sensor may be attached to the first manifold structure by way of mounting holes (e.g., mounting screw holes 110-131 provided around the sensor interface 110-13) arranged near the sensor interface 110-13, thereby being supported by the first manifold structure. In addition, a plurality of wire harness fixing threaded holes 110-14, 110-15, and 110-16 are scattered in exposed or easily accessible areas (e.g., on the side facing away from the second manifold structure 120) of the first and second main manifold channels. These wire harness threaded holes can be used to install wire harness devices for accommodating, routing, and managing cables attached to sensors of the nested manifold assembly 100, as well as cables of BOP devices arranged around the nested manifold assembly 100. Integrating these auxiliary functional features into the local space of the nested manifold assembly 100 not only reduces the overall spatial volume of the fuel cell system but also helps decrease the number of bulk components, thereby lowering production costs. Furthermore, as is clearly visible in FIGS. 2A-2C, the first manifold structure 110 and the second manifold structure 120 adopt a channel configuration in which reinforcing structures such as reinforcing ribs, reinforcing ridges, H-shaped support portions, grid structures, etc., are simply added to the outer wall. This allows the manifold assembly to meet structural strength requirements while reducing weight and improving material cost efficiency.

The second manifold structure 120, which nests with the first manifold structure 110, is connected to the first manifold structure 110 in a detachable manner, allowing for individual replacement. In the embodiment shown in FIGS. 2A-2C, the first manifold structure 110 and the second manifold structure 120 are fixed to each other by way of threaded connections. Specifically, as best seen in FIG. 2A, in the first manifold structure 110, a plurality of bushing structures 110-7 (e.g., formed by injection-molded metal bushing processes) are formed along the top of the first main manifold channel 110-1 and the side of the second main manifold channel 110-2. Corresponding interfacing screw holes 120-7 (e.g., formed by injection-molded threaded insert processes) are formed at positions in the second manifold structure 120 corresponding to the bushing structures 110-7 of the first manifold structure 110, such that the bolt shank can be inserted through the bushing structure 110-7 into the interfacing screw hole 120-7 and screwed in, thereby securing the first manifold structure 110 and the second manifold structure 120 together. Although FIG. 2A shows four bushing structures on the first manifold structure and four interfacing screw holes on the second manifold structure, the number of bushing structures and interfacing screw holes may be greater or fewer, and their distribution is not limited to the positions shown in FIG. 2A, as long as they are accessible for disassembly and assembly operations.

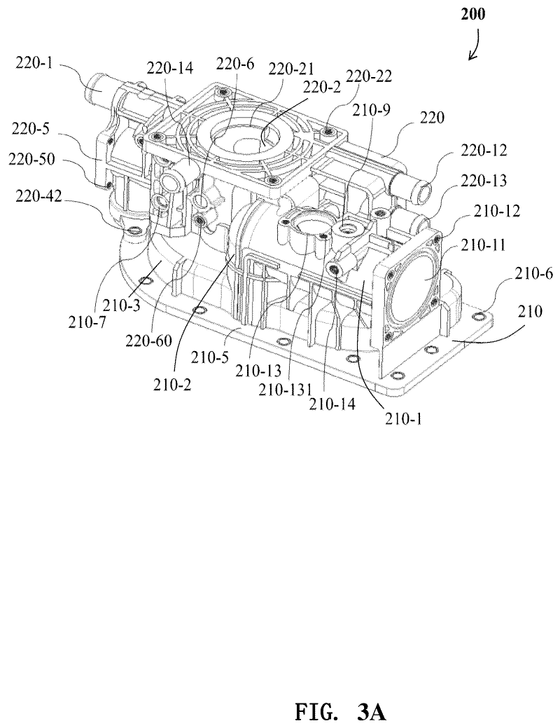

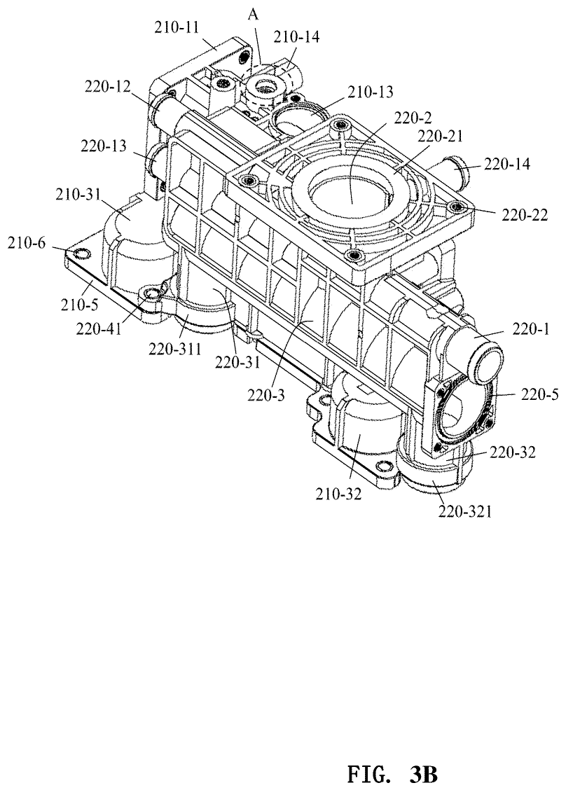

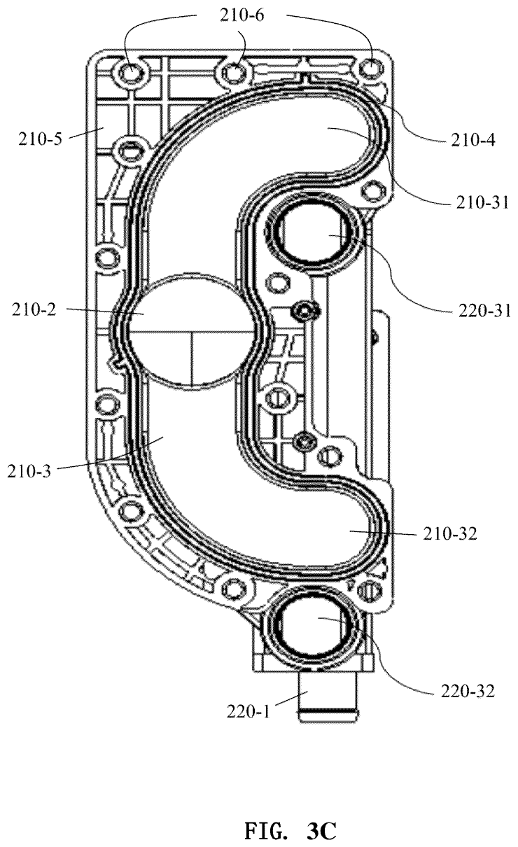

Referring to FIG. 2B, the second manifold structure 120 comprises a first second manifold end plate interface 120-31 and a second second manifold end plate interface 120-32, both configured to interface with the first coolant inlet 15-1 and the second coolant inlet 15-2 of the stack end plate 1, and both extending in a direction parallel to the second direction, a branch third channel 120-3, which extends along the first direction and connects the first second manifold end plate interface 120-31 to the second second manifold end plate interface 120-32, a main second manifold channel 120-2, which, from a position on the branch third channel 120-3 located between the first second manifold end plate interface 120-31 and the second second manifold end plate interface 120-32 (preferably at a location equidistant from the first second manifold end plate interface 120-31 and the second second manifold end plate interface 120-32), extends away from the branch third channel 120-3 in the second direction, and a main first manifold channel 120-1 which extends from the end of the main second manifold channel 120-2 opposite to the end connected to the branch third channel 120-3, in the first direction. The main first manifold channel 120-1, main second manifold channel 120-2, branch third channel 120-3, and the first and second second manifold end plate interfaces 120-31, 120-32 are in fluid communication, thereby allowing the working medium (coolant in this embodiment) to flow from the main inflow opening 120-11 of the main first manifold channel 120-1, through the main first manifold channel 120-1 and main second manifold channel 120-2, and via the branch third channel 120-3 to the first and second second manifold end plate interfaces 120-31, 120-32 for supply to the first and second stacks, respectively. In the example of FIGS. 2A-2C, medium bypass branches 120-12, 120-13, and 120-14 are connected to the main first manifold channel 120-1 near the main inflow opening 120-11. However, it is also contemplated that the medium bypass branches may be connected to the main second manifold channel 120-2 of the second manifold structure 120, so that the working media from the main supply source and auxiliary supply source are combined before reaching the branch third channel 120-3, as will be described below with reference to FIGS. 3A-3C. Furthermore, although FIG. 2B shows the medium bypass branches 120-12, 120-13 extending along the third direction and the medium bypass branch 120-14 extending from medium bypass branch 120-12 parallel to the first direction, the orientation of the medium bypass branches may differ from that shown in FIG. 2B to accommodate the specific arrangement of related BOP devices in particular applications.

Similar to the first manifold structure 110, the main body of the second manifold structure 120 is integrally formed of plastic (e.g., PPS+GF40%) by injection molding. The process interfaces 120-4, 120-5 formed by the injection molding process are sealed in subsequent steps, for example, by screwing plugs into screw holes 120-40, 120-50 formed around the respective process interfaces 120-4, 120-5. Furthermore, at the junction between the main first manifold channel 120-1 and the second main manifold channel 120-2 of the second manifold structure 120, a sensor interface 120-6 is also formed for interfaceing with a sensor, together with screw holes 120-60 provided around the sensor interface 120-6 for mounting the sensor. A wire harness bayonet 120-7 is formed on the top of the main first manifold channel 120-1, adjacent to the sensor interface 120-6, for bundling the cables of the sensor interfaced with the sensor interface 120-6 as well as other cables. As previously mentioned, the integration of these auxiliary functional features can facilitate a compact and intensive arrangement structure.

The second manifold structure 120 is nested with the first manifold structure 110. Specifically, as best seen in FIG. 20, when assembled, the first first manifold end plate interface 110-31 is disposed adjacent to the first second manifold end plate interface 120-31, and the second first manifold end plate interface 110-32 is disposed adjacent to the second second manifold end plate interface 120-32. In this regard, furthermore, the portion of the flange 110-5 adjacent to receive the first second manifold end plate interface 120-31 and the second second manifold end plate interface 120-32 is formed to define arcuate openings, which may circumferentially surround the first and second manifold end plate interfaces by at least 90°, and preferably at least 180°. Corresponding annular flanges 120-311 and 120-321 are formed on the circumferential portions of the first second manifold end plate interface 120-31 and the second second manifold end plate interface 120-32, such that when the first and second manifold structures are assembled, the annular flanges are at least partially seated on the flange 110-5, thereby allowing the first manifold structure 100 and the second manifold structure 120 to be conveniently nested. Specifically, the first second manifold end plate interface 120-31 and the second second manifold end plate interface 120-32 may first be inserted into the arcuate openings near the first first manifold end plate interface 110-31 and the second first manifold end plate interface 110-32, until the annular flanges 120-311 and 120-321 abut against the flange 110-5 of the first manifold structure 110, thereby preliminarily nesting and fixing the first and second manifold structures; then, bolts are inserted through the bushing structure into the corresponding screw holes and tightened to fasten the first and second manifold structures together, thereby completing the assembly of the nested manifold assembly.

Accordingly, as can be observed from FIGS. 2A and 2B after assembly, the respective channels of the first and second manifold structures are arranged in a staggered manner. Specifically, for channels extending along the first direction, as can be readily observed in conjunction with FIGS. 2A and 2B, taking the flange 110-5 attached to the end surface of the stack end plate 1 as a reference, the third branch channel 110-3 of the first manifold structure 110 extends within a first height range from the flange 110-5, followed by the third branch channel 120-3 of the second manifold structure 120 extending within a second height range from the flange 110-5, higher than the first height range; then, the main first manifold channel 110-1 of the first manifold structure 110 extends within a third height range from the flange 110-5, higher than the second height range; and subsequently, the main first manifold channel 120-1 of the second manifold structure 120, as well as the medium bypass branches 120-12, 120-13, and 120-14, extend within a fourth height range from the flange 110-5, further above the third height range. Additionally, for channels extending along the second direction, as can be readily observed in conjunction with FIGS. 2A to 2C, the first second manifold end plate interface 120-31 and the second second manifold end plate interface 120-32 are arranged in the first direction offset from the first first manifold end plate interface 110-31 and the second first manifold end plate interface 110-32, respectively. Accordingly, the second main manifold channel 120-2, located between the first first manifold end plate interface and the second first manifold end plate interface, is arranged offset from the second main manifold channel 110-2, which is located between the first second manifold end plate interface and the second second manifold end plate interface. Thus, although the first and second manifold structures are connected in a detachable manner, the nested manifold assembly 100 has a volume comparable to a manifold assembly integrally formed from the first and second manifold structures. Alternatively, the first and second manifold structures may also be integrally formed without departing from the spirit and scope of the present disclosure.

FIGS. 3A-3C illustrate another embodiment of a nested manifold assembly according to the principles of the present disclosure, which may be used as an oxidant and coolant outlet manifold assembly. Except for the aspects specifically stated in the following paragraphs, the nested manifold assembly 200 is substantially the same as the nested manifold assembly 100 described above in conjunction with FIGS. 2A-2C. Accordingly, the above descriptions of the inflow opening 110-11 of the first manifold structure 110 of the nested manifold assembly 100, the mounting flange 110-12 around the inflow opening 110-11, the first main manifold channel 110-1, the second main manifold channel 110-2, the third branch channel 110-3, the first first manifold end plate interface 110-31, the second first manifold end plate interface 110-32, the groove 110-4, the flange 110-5, the through hole 110-6, and the bushing structure 110-7 are equally applicable to the outflow opening 210-11 of the first manifold structure 210 of the nested manifold assembly 200, the mounting flange 210-12 around the outflow opening 210-11, the first main manifold channel 210-1, the second main manifold channel 210-2, the third branch channel 210-3, the first first manifold end plate interface 210-31, the second first manifold end plate interface 210-32, the groove 210-4, the flange 210-5, the through hole 210-6, and the bushing structure 210-7. Furthermore, the above descriptions regarding the first secondary manifold end plate interface 120-31, second secondary manifold end plate interface 120-32, annular flanges 120-311 and 120-321, branch third channel 120-3, main secondary channel 120-2, main first manifold channel 120-1, process interface 120-5, threaded hole 120-50 within the process interface, sensor interface 120-6, and the threaded hole 120-60 provided near the sensor interface of the nested manifold assembly 100 are equally applicable to the first secondary manifold end plate interface 220-31, second secondary manifold end plate interface 220-32, annular flanges 220-311 and 220-321, branch third channel 220-3, main second manifold channel 220-2, main first manifold channel 220-1, process interface 220-5, threaded hole 220-50 within the process interface, sensor interface 220-6, and the threaded hole 220-60 provided near the sensor interface of the nested manifold assembly 200. For the sake of brevity, the relevant content will not be repeated here.

In the nested manifold assembly 200 used as an outlet manifold assembly, the main first manifold channel 220-1 of the second manifold structure 220 extends in a direction parallel to but opposite from the main first manifold channel 210-1 of the first manifold structure 210. Meanwhile, the medium bypass branches 220-12, 220-13, and 220-14 of the second manifold structure 220 are connected to the main second manifold channel 220-2, and extend from the main second manifold channel 120-2 in directions parallel but opposite to the main first manifold channel 220-2 (medium bypass branches 220-12, 220-13) and in a perpendicular direction (medium bypass branch 220-14). Correspondingly, the end of the main second manifold channel 220-2 opposite to the end connected to the branch third channel 220-3 is open and configured as a BOP connection interface 220-21, for interfacing with downstream BOP devices so as to guide the working medium flow between the main first manifold channel 220-1 and the medium bypass branches 220-12, 220-13, and 220-14. Multiple mounting screw holes 220-22 are provided around the BOP connection interface 220-21 for mounting downstream BOP devices onto the nested manifold assembly 200, thereby arranging them in close proximity to the manifold assembly.

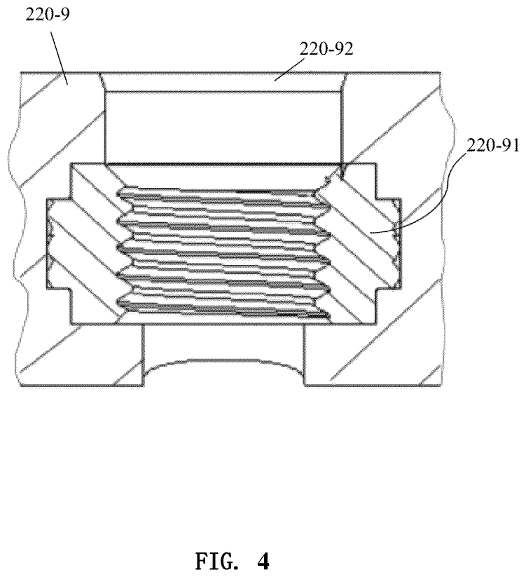

Sensor interfaces 210-13 and 210-9, for detecting the physical and/or chemical characteristics of the working medium flowing in the first manifold structure 210, are provided at approximately the central portion of the first main manifold channel 210-1, so that sensors for detecting the physical and/or chemical characteristics of the working medium flowing in the second manifold structure 220 may be mounted on the side of the second main manifold channel 210-2 opposite to the first main manifold channel 210-1. Threaded holes 210-131 are formed around the sensor interface 210-13 to facilitate bolted connection of sensors interfaced with sensor interface 210-13 to the sensor interface 210-13. Unlike sensor interface 210-13, sensor interface 210-9 is threadedly connected to the corresponding sensor by way of a metal threaded insert 210-91 embedded therein. Specifically referring to FIG. 4, the metal threaded insert 210-91 is overmolded within the plastic body of sensor interface 210-9, forming a channel section narrower than the opening 210-92 of sensor interface 210-9 (for example, by utilizing the difference in thermal expansion coefficients between plastic and metal). Thus, a sealing member may be installed on the metal threaded insert 210-91 to provide radial sealing between the sensor inserted into sensor interface 210-9 and the sensor interface 210-9.

Returning to FIGS. 3A-3C, in the embodiment of the nested manifold assembly 200 illustrated in FIGS. 3A-3C, only one wire harness fixing threaded hole 210-14 is provided. Specifically, as shown in FIG. 3A, the wire harness fixing threaded hole 210-14 is arranged adjacent to sensor interface 210-9, and sensor interface 210-9 is further arranged adjacent to sensor interface 210-13 on the opposite side, such that the cables of sensors interfaced with sensor interfaces 210-13 and 210-9 can be conveniently managed collectively by way of a wire harness device inserted into the wire harness fixing threaded hole 210-14.

In addition, apart from connecting the first and second manifold structures using the bushing structure and matching threaded holes as described above with reference to FIGS. 2A-2C, the second manifold structure 220 of the nested manifold assembly 200 is also fastened to the first manifold structure 210 and further to the stack end plate 1 by way of bolts passing through through holes 220-41 and 220-42 in the extensions of the annular flanges 220-311 and 220-312 of the second manifold structure 220, aligned with the through holes 210-6 on flange 210-5.

The differences between the nested manifold assembly 200 of FIGS. 3A-3C and the nested manifold assembly 100 of FIGS. 2A-2C relate to the positions at which they are installed, the BOP devices or BOP device interfaces to which they are connected, their orientation relative to the same BOP device, and the arrangement of surrounding BOP devices, among other aspects. Accordingly, the differences between the two should be broadly understood as modifications made to the nested manifold assembly according to the principles of the present disclosure to accommodate different application requirements.

Accordingly, although the principles of the nested manifold assembly according to the present disclosure have been described in connection with the inventor's known preferred embodiments, those skilled in the art, based on the disclosures and teachings herein, are capable of making further modifications, substitutions, and/or variations to the embodiments disclosed herein as appropriate for specific circumstances. For example, contrary to the specific exemplary situations described above, the first manifold structure may be employed as a coolant delivery channel, and the second manifold structure may be employed as an oxidant delivery channel. It is therefore understood that such modifications, substitutions, and/or variations are also considered to be within the scope of the present disclosure, without departing from the spirit and teachings of the present disclosure.

What is claimed is:

1. A manifold assembly for a dual-stack fuel cell system, comprising:
a first manifold structure configured to deliver one of an oxidant and a coolant, the first manifold structure comprising a first branch channel and a first main manifold channel in fluid communication with the first branch channel and extending at least partially superposed over the first branch channel, wherein the first branch channel is open on a side opposite to the first main manifold channel for sealing connection to a surface of a stack end plate, such that one of the oxidant and coolant is guided along the surface of the stack end plate therein; and
a second manifold structure configured to deliver the other of the oxidant and coolant, the second manifold structure comprising two end plate interfaces configured to be connected to the stack end plate in a manner perpendicular to the surface of the stack end plate, a second branch passage fluidly connecting the two end plate interfaces, and a second main manifold channel in fluid communication with and extending at least partially superposed over the second branch passage.

2. The manifold assembly according to claim 1, wherein the first manifold structure and the second manifold structure are each integrally formed and are detachably connected together.

3. The manifold assembly according to claim 1, wherein the first branch channel of the first manifold structure is formed with a generally straight central channel section and two end channel sections extending substantially perpendicular to the central channel section from opposite ends thereof, and the first main manifold channel is fluidly connected to the first branch channel at an intermediate position of the central channel section.

4. The manifold assembly according to claim 3, wherein the two end plate interfaces of the second manifold structure are respectively disposed adjacent to a corresponding one of the two end channel sections, such that one of the two end plate interfaces is located between the two end channel sections and one of the two end channel sections is located between the two end plate interfaces.

5. The manifold assembly according to claim 4, wherein the two end plate interfaces are arranged in alignment with the two end channel sections, and the end plate interface located between the two end channel sections is adjacent to the central channel section.

6. The manifold assembly according to claim 5, wherein the first main manifold channel is formed with a first main manifold channel section I, which extends perpendicular to the central channel section of the first branch channel, and a first main manifold channel section II, which extends parallel to the central channel section from the first main manifold channel section I; and the second main manifold channel is formed with a second main manifold channel section I, which extends perpendicular to the second branch passage, and a second main manifold channel section II, which extends parallel to the second branch passage from the second main manifold channel section I.

7. The manifold assembly according to claim 6, wherein the first branch channel, the second branch passage, the first main manifold channel section II, and the second main manifold channel section II are arranged in a sequentially staggered manner, and/or the second main manifold channel section I is connected to the second branch passage at an equal distance from both end plate interfaces.

8. The manifold assembly according to claim 7, wherein the manifold assembly further comprises at least one of the following:
a flat flange extending outward from the channel opening edge of the first branch channel, the flange being configured to abut the surface of the stack end plate and including a plurality of through holes around a third branch channel passing therethrough;
an arcuate opening formed near each of the two end channel sections of the first branch channel for receiving an end plate interface, and an annular flange formed on each of the two end plate interfaces for controlling insertion of the end plate interface into the arcuate opening;
a sensor interface provided in the first main manifold channel of the first manifold structure for detecting physical and/or chemical characteristics of one of the oxidant and coolant, and threads provided around and/or inside the sensor interface;
a sensor interface provided in the second main manifold channel of the second manifold structure for detecting physical and/or chemical characteristics of the other of the oxidant and coolant, and threads provided around the sensor interface;
one or more wire harness fixing threaded holes integrated into the first main manifold channel of the first manifold structure for mounting wire harness devices;
a mounting flange formed at the end of the first main manifold channel section II of the first manifold structure, opposite to the end connected to the first main manifold channel section I, for interfacing with a device arranged upstream or downstream of the first manifold structure, and mounting screw holes provided in the mounting flange;
a mounting flange formed at the end of the second main manifold channel section I of the second manifold structure, opposite to the end connected to the second branch passage, for interfacing with a device arranged upstream or downstream of the second manifold structure, and mounting screw holes provided in the mounting flange;
a plurality of medium bypass branches extending parallel and/or perpendicular to the second main manifold channel section II; and
the first manifold structure and the second manifold structure assembled together by way of bolted connection, wherein the bolted connection at least includes a bushing structure formed on the first manifold structure for the passage of bolts and interfacing threaded holes formed on the second manifold structure aligned with the bushing structure.

9. A stack end plate for a dual-stack fuel cell system for use with the manifold assembly according to claim 1, wherein the stack end plate is formed with end interfaces for input and output of oxidant and coolant for the first and second stacks of the dual-stack fuel cell system, wherein the end interfaces for input of oxidant and coolant for the first and second stacks are arranged in alignment on one side of the stack end plate, and the end interfaces for output of oxidant and coolant for the first and second stacks are arranged in alignment on the other side of the stack end plate opposite to said one side.

10. A dual-stack fuel cell system, comprising: first and second stacks arranged side by side; a stack end plate for encapsulating the first and second stacks according to claim 9; a manifold assembly sealingly connected to the oxidant and coolant input end interfaces of the stack end plate; and another manifold assembly sealingly connected to the oxidant and coolant output end interfaces of the stack end plate.
